(19) United States
(12) Patent Application Publication
(10) Pub. No.: US 2009/0219616 A1
(43) Pub. Date: Sep. 3, 2009

(54) Theater-type projection screen

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314-1176, US

(21) Appl. No.: 12/078,071

(22) Filed: Mar. 27, 2008

(30) Foreign Application Priority Data
Feb. 29, 2008 (KR) 10-2008-0014434

(51) Int. Cl. G03B 21/56

(52) U.S. Cl. 359/450

(57) ABSTRACT

A theater-type projection screen is disclosed, which is capable of achieving a theater-like stage structure with one projection screen, being implemented in a wall-mounting form or in a stand form. The theater-type projection screen comprises a screen frame formed in a dual structure including an outer frame and an inner frame which are separably connected to each other. The outer frame is made of various materials and in various designs, and structured as a theater stage having a predetermined space allowing movement of a stage curtain therein. The inner frame is equipped with a motor, a fixing shaft, a rotational shaft, and a static screen. According to this structure, the theater-type projection screen is capable of implementing a theatrical atmosphere when in use, and protecting a surface of the projection screen while showing an aesthetic design thereof when not in use.

### BACKGROUND OF THE INVENTION

1. Field of the Invention

The present invention relates to a wall-mounted projection screen for a home theater. More particularly, the present invention relates to a theater-type projection screen enabling wall-mounting or stand-type mounting with one structure and capable of preventing exposure of the screen and protecting a surface of the screen while being harmonized with the surrounding interior design of the mounting place when not in use, and capable of achieving a theatrical atmosphere when used as the projection screen.

2. Description of the Related Art

Generally, a conventional wall-mounted projection screen has a rollup structure without a frame. Since such a conventional wall-mounted projection screen is mounted regardless of variable surrounding designs, a user can hardly feel a theatrical atmosphere during movie watching.

Meanwhile, a frame-type projection screen, though having a simple structure, is disadvantageous since it deteriorates the atmosphere of the surrounding interior place by plainly exposing the color of the screen. Furthermore, because the exposed surface of the projection screen may easily be damaged, a dedicated work for constructing a screen shielding device is required. Also, with the frame-type projection screen, it is difficult to construct operating structures such as a motor and a rotational shaft for opening and closing a stage curtain.

### SUMMARY OF THE INVENTION

Therefore, the present invention has been made in view of the above problems, and it is an object of the present invention to provide a theater-type projection screen capable of improving the aesthetic external appearance by implementing a theater-like design with diverse materials such as plastic applied to a frame, enabling replacement of the external appearance as necessary, stably mounting a stage curtain to the frame and an operating device which moves the stage curtain in lateral directions, implementing a theatrical atmosphere by providing a static screen to a rear side of the frame and a theater stage structure to a surface of the static screen so as to open and close the stage curtain, enabling wall-mounting thereof by configuring the above structure as an integrated structure, and also enabling a stand-type use by attaching a stand structure.

In accordance with the present invention, the above and other objects can be accomplished by the provision of a theater-type projection screen comprising a screen frame, as shown in FIG. 1, FIG. 2 and FIG. 3, the screen frame formed in a dual structure including an outer frame 1a and an inner frame 1b, wherein the outer frame 1a made of transformable and aesthetic materials such as acryl, plastic or glass, and structured as a theater stage having a predetermined space for a stage curtain 3 to move horizontally and vertically therein, and the inner frame 1b made of a solid material such as metal and equipped with a motor, the stage curtain, a rotational shaft, and a fixing shaft 4a mounted therein and a static screen 2 mounted on a rear side thereof, the stage curtain 3 being openable and closable horizontally and vertically.

In the dual structure, the outer frame and the inner frame are separable and connectable with respect to each other.

According to an embodiment of the present invention, as shown in FIG. 1 through FIG. 3, a theater-type projection screen comprises a screen frame formed in a dual structure including an outer frame and an inner frame, wherein the outer frame is made of various materials and structured as a theater stage having a predetermined space for a stage curtain to move horizontally and vertically therein, and the inner frame is equipped with a motor, a rotational shaft, and the stage curtain formed therein, and a static screen formed on a rear side thereof, so that the stage curtain and the static screen are implemented simultaneously in one projection screen structure.

Here, the outer frame and the inner frame may be separably connected with respect to each other.

The stage curtain may comprise a left stage curtain and a right stage curtain, and the rotational shaft may comprise a left rotational gear and a right rotational gear.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the appearance and structure of a theater-type projection screen according to an embodiment of the present invention;

FIG. 2 is a side sectional view of the theater-type projection screen according to the embodiment of the present invention;

FIG. 3 is a view showing the structure of an inner frame according to the embodiment of the present invention; and

FIG. 4 is a view illustrating the operation of an inner frame according to another embodiment of the present invention.

### DETAILED DESCRIPTION OF THE PREFERRED EMBODIMENTS

Hereinafter, exemplary embodiments of the present invention will be described in detail with reference to the accompanying drawings.

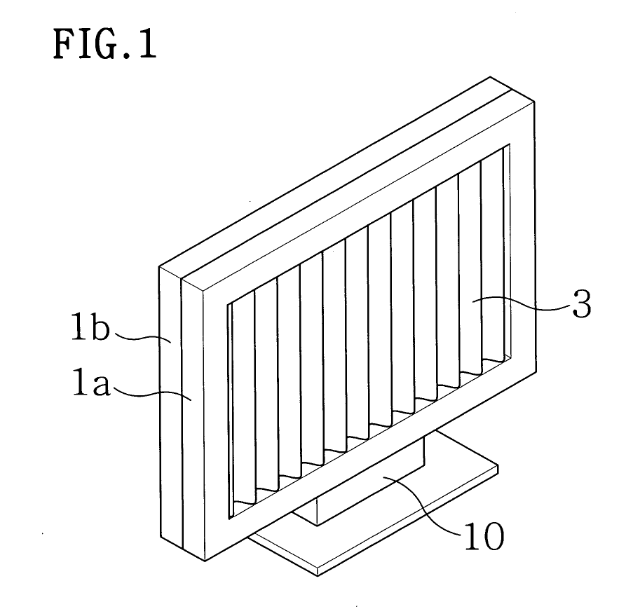

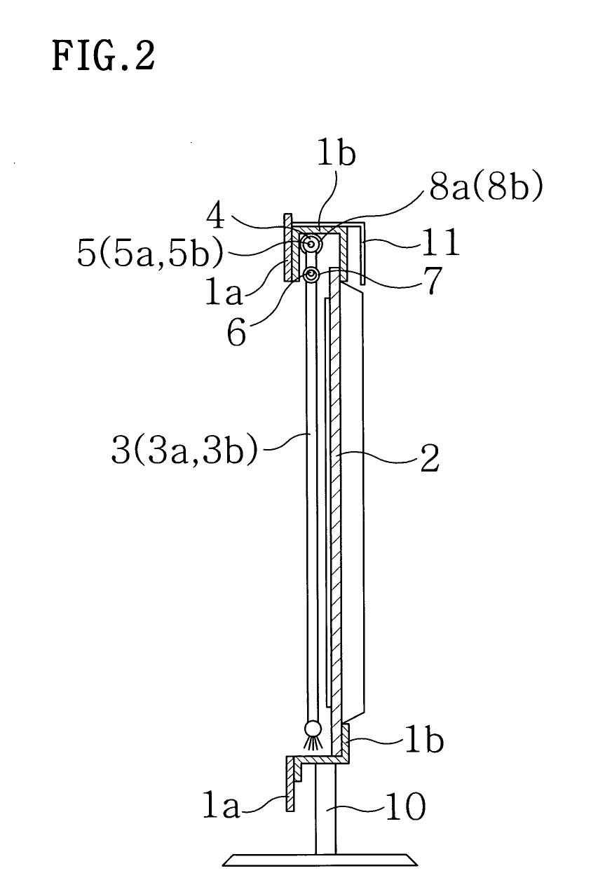

As shown in FIG. 1 and FIG. 2, a theater-type projection screen according to an embodiment of the present invention comprises a screen frame 1 including an outer frame 1a and an inner frame 1b, a static screen 2, a stage curtain 3, a motor 4, and a rotational shaft 5.

More specifically, the screen frame 1 is characterized by a dual structure comprising the outer frame 1a and the inner frame 1b. The outer frame 1a has a stage form capable of adopting variable appearances and designs. The inner frame 1b has a structure for mounting the stage curtain 3, the motor 4, the rotational shaft 5, and a fixing shaft 6 thereto.

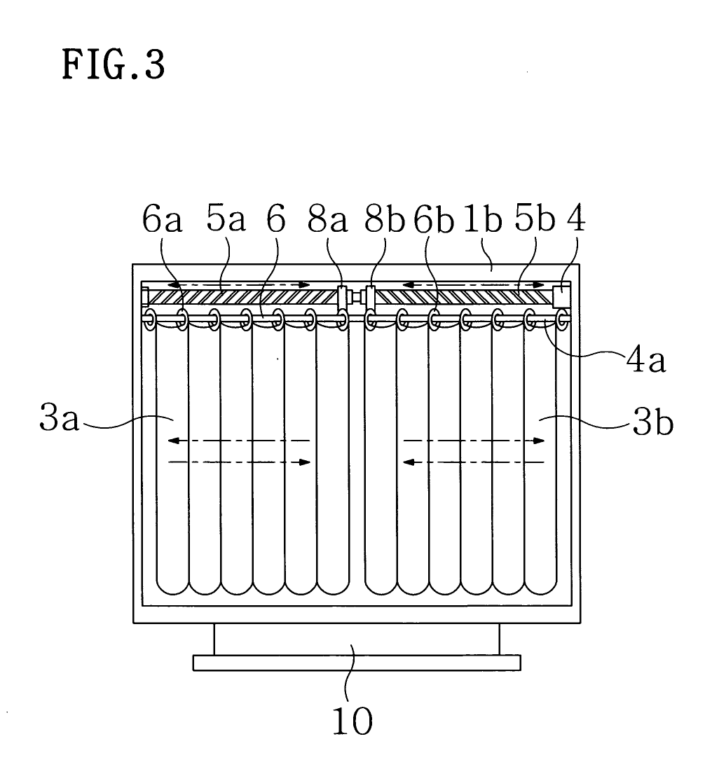

As shown in FIG. 3, the inner frame 1b and the outer frame 1a are separably connected with respect to each other by a dedicated connecting device (not shown).

In other words, the inner frame 1b for fixing the operating structures and the outer frame 1a having variable forms are separately formed to be separably connected.

As shown in FIG. 2 and FIG. 3, the static screen 2 is characterized to maintain uniformity being insusceptible to weather or humidity, by being securely connected to the inner frame 1b.

More specifically, as the whole outline of the projection screen is connected with the inner frame 1b so that every side of the projection screen is supported by the inner frame 1b, the projection screen is structured as the static screen 2 capable of maintaining uniformity.

The stage curtain 3 comprising a left stage curtain 3a and a right stage curtain 3b is constructed as follows. As shown in FIG. 2, the rotational shaft 5 is connected with the motor 4, and a helical gear is formed on a surface of the rotational shaft 5 with respect to the central axis of the rotational shaft 5. The helical gear comprises a leftward rotational gear 5a and a rightward gear 5b having symmetrically opposite rotational directions from each other.

Left movable rings 6a and right movable rings 6b are connected to each one side of the left and right stage curtains 3a and 3b, respectively. As the rotational shaft 5 is rotated by the motor 4, each innermost one of left and right movable rings 6a and 6b, disposed almost in the middle between the left and right stage curtains 3a and 3b, and left and right movable nuts 8a and 8b connected to each upper part of the innermost left and right movable rings 6a and 6b are moved along one rotational shaft 5 through the left and right rotational gears 5a and 5b of the fixing shaft 6, thereby moving the left and right stage curtains 3a and 3b to the left and the right, respectively. Thus, the static screen 2 within the stage curtain 3 can be exposed or covered like in a theater.

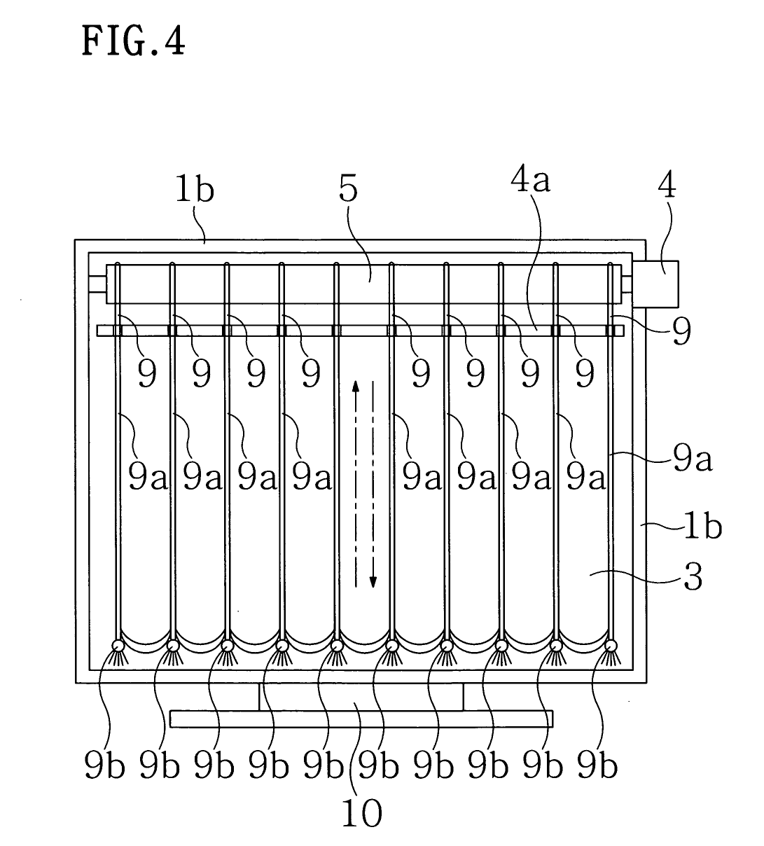

According to another embodiment of the present invention, as shown in FIG. 4, a wire 9 is formed in groove lines 9a vertically formed between every adjacent pair of sections of the stage curtain 3, and connected to a lower part 9b of the stage curtain 3 through a hollow formed in a horizontal fixing shaft 4a and the groove lines 9a of each section of the stage curtain 3. Therefore, when the wire 9 is rolled up by the rotational shaft 5, the stage curtain lower part 9b can be moved up and down according to the vertical rolling and unrolling operations of the wire 9. As a result, the static screen 2 fixed to the rear side of the screen frame 1 can be opened and closed in a vertical direction.

In the structure of FIG. 1, after the projection screen is mounted on the wall by connecting a wall-mounting bracket 11 to the rear side of the inner frame 1b, when the motor 4 is driven, the stage curtain 3 is opened, being divided to the left and the right, thereby exposing the static screen 2.

In the structure of FIG. 4, on the other hand, upon driving of the motor 4, the wires 9 of each groove line 9a formed between every two sections of the stage curtain 3 are rolled up around the rotational shaft 5. Accordingly, the stage curtain 3 mounted under the horizontal fixing shaft 4a is gathered up into several folds, thereby exposing the static screen 2 mounted on the rear side of the screen frame 1.

In the state of FIG. 1 and FIG. 4, if a stand 10 is connected to a lower part of the screen frame 1, the projection screen can be used in the stand form.

As apparent from the above description, the present invention provides a theater-type projection screen having a dual structure comprising an outer frame and an inner frame which are separably connected to each other. The outer frame is capable of implementing variable designs using various materials such as acryl and plastic and also implementing a theater stage structure by allowing a stage curtain to move in a lower space thereof. The inner frame is equipped with the stage curtain, and operating structures including a rotational shaft for opening and closing the stage curtain.

Consequently, variable theatrical appearances and designs can be achieved through the outer frame while stability of the theater structures can be achieved through the inner frame.

Moreover, since the theater-type projection screen including the stage curtain may be mounted on the wall or on the desk in the stand form, a theatrical atmosphere can be achieved with the one projection screen. In addition, while a static screen is protected, the curtain stage 3 of variable designs can be harmonized with the surrounding interior.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A theater-type projection screen comprising a screen frame formed in a dual structure including an outer frame and an inner frame,
the outer frame configured as a theater stage having a predetermined space for a stage curtain to move horizontally and vertically therein, and
the inner frame equipped with a motor, a rotational shaft, and the stage curtain, and a static screen formed on a rear side thereof,
whereby the stage curtain and the static screen are implemented simultaneously in one projection screen structure.

2. The theater-type projection screen according to claim 1, wherein the dual structure of the outer frame and the inner frame are separable and connectable with respect to each other.

3. The theater-type projection screen according to claim 1, wherein the stage curtain comprises a left stage curtain and a right stage curtain, and the rotational shaft comprises a left rotational gear and a right rotational gear.

4. The theater-type projection screen according to claim 1, further comprising a wall-mounting device connected to a rear side of the screen frame so as to enable use of the projection screen in a wall-mounting form.

5. The theater-type projection screen according to claim 1, further comprising a stand connected to a lower part of the screen frame so as to enable the projection screen to be used in a stand form.
